(19) United States
(12) Patent Application Publication
(10) Pub. No.: US 2022/0188143 A1
(43) Pub. Date: Jun. 16, 2022

(54) PROCESS MINING FOR MULTI-INSTANCE PROCESSES

(71) Applicant: UiPath, Inc., New York, NY (US)

(72) Inventors: Roeland Johannus SCHEEPENS, Eindhoven (NL); Rob Mattheu Anna TEEUWEN, Eindhoven (NL)

(73) Assignee: UiPath, Inc., New York, NY (US)

(21) Appl. No.: 17/119,987

(22) Filed: Dec. 11, 2020

(51) Int. Cl. G06F 9/46

(52) U.S. Cl. CPC G06F 9/46

(57) ABSTRACT

Systems and methods for performing process mining on a multi-instance process comprising one or more multi-instance subprocesses are provided. An event log of the multi-instance process is divided into a main log and one or more sublogs by collapsing events of each of the one or more multi-instance subprocesses into a single activity. A process graph is generated for the main log and for each of the one or more sublogs. The generated process graphs are combined into a combined process graph. The combined process graph is output.

### TECHNICAL FIELD

The present invention relates generally to process mining, and more particularly to process mining for multi-instance processes.

### BACKGROUND

A process is comprised of sequences of activities executed by one or more computers to provide various services. Often times, a process may include one or more multi-instance subprocesses. A multi-instance subprocess is a subprocess that is executed as multiple instances in parallel during each execution of the process. Traditional process mining techniques are not able to distinguish between different instances of multi-instance subprocesses and are therefore not suitable for applying to processes comprising multi-instance subprocesses. For example, traditional process mining techniques incorrectly generate process graphs that represent a multi-instance subprocess as a single instance activity.

### BRIEF SUMMARY OF THE INVENTION

In accordance with one or more embodiments, systems and methods for performing process mining on a multi-instance process comprising one or more multi-instance subprocesses are provided. An event log of the multi-instance process is divided into a main log and one or more sublogs by collapsing events of each of the one or more multi-instance subprocesses into a single activity. Each of the one or more sublogs corresponds to a respective one of the one or more multi-instance subprocesses. A process graph is generated for the main log and for each of the one or more sublogs. The generated process graphs are combined into a combined process graph. The combined process graph is output. In one embodiment, the multi-instance process is a robotic process automation multi-instance process.

In one embodiment, the event log is divided by, for each respective hierarchical level of the multi-instance process, omitting events corresponding to a hierarchical level higher than the respective hierarchical level of the multi-instance process from the event log. The events may be omitted by filtering the event log based on a subprocess identifier.

In one embodiment, the process graph generated for a sublog corresponding to a particular one of the one or more multi-instance subprocesses is inserted into the process graph generated for the main log. The particular multi-instance subprocess in the process graph generated for the main log is replaced with a start multi-instance subprocess node and an end multi-instance subprocess node. A start node and an end node in the process graph generated for the sublog corresponding to the particular multi-instance subprocess is replaced with a start multi-instance subprocess node and an end multi-instance subprocess node respectively. The start multi-instance subprocess node and the end multi-instance subprocess node of the process graph generated for the sublog corresponding to the particular multi-instance subprocess are inserted at the start multi-instance subprocess node and the end multi-instance subprocess node of the process graph generated for the main log respectively.

In one embodiment, a loop from an end node of each respective one of the one or more multi-instance subprocesses to a start node of the respective one of the one or more multi-instance subprocesses is inserted. Conformance checking is performed based on the combined process graph.

In one embodiment, a graph layout is separately computed for the process graphs generated for the main log and for each of the one or more sublogs.

In one embodiment, the combined process graph is displayed.

These and other advantages of the invention will be apparent to those of ordinary skill in the art by reference to the following detailed description and the accompanying drawings.

### BRIEF DESCRIPTION OF THE DRAWINGS

FIG. 1 shows an exemplary multi-instance process, in accordance with one or more embodiments;

FIG. 2 shows a workflow for performing process mining on a multi-instance process, in accordance with one or more embodiments;

FIG. 3 shows a method for performing process mining on a multi-instance process, in accordance with one or more embodiments;

FIG. 4 shows an exemplary event log of multi-instance process 100 of FIG. 1, in accordance with one or more embodiments;

FIG. 5 shows a process graph generated from a main log of multi-instance process 100 of FIG. 1 and a process graph generated from a sublog of multi-instance process 100 of FIG. 1, in accordance with one or more embodiments;

FIG. 6 shows a workflow for combining main graph 502 and subgraph 504 of FIG. 5 into a combined process graph, in accordance with one or more embodiments; and

FIG. 7 is a block diagram of a computing system according to an embodiment of the invention.

### DETAILED DESCRIPTION

A process is a predefined sequence of activities that are executed by one or more computers to provide services for a number of different applications, such as, e.g., administrative applications (e.g., onboarding a new employee), procure-to-pay applications (e.g., purchasing, invoice management, and facilitating payment), and information technology applications (e.g., ticketing systems). Often times, a process may include one or more multi-instance subprocesses. A subprocess is a compound activity that represents a collection of activities and/or other subprocesses. A multi-instance subprocess is a subprocess that is executed as multiple instances in parallel during each execution of the process. A process that includes one or more multi-instance subprocesses is referred to herein as a multi-instance process.

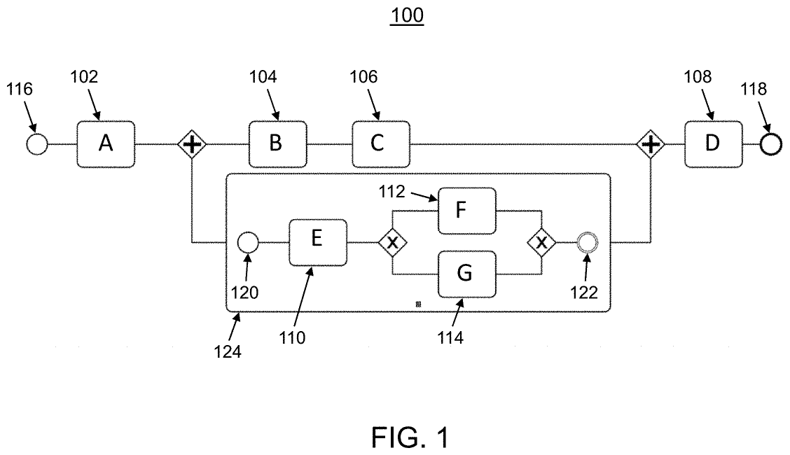

FIG. 1 shows an exemplary multi-instance process 100, in accordance with one or more embodiments. Multi-instance process 100 comprises activities 102-114 between start node 116 and end node 118. Activities 110-114 between start node 120 and end node 122 form a multi-instance subprocess 124 of multi-instance process 100. For each instance of execution of multi-instance process 100, a plurality of instances of multi-instance subprocess 124 are executed in parallel. In one embodiment, multi-instance process 100 is an RPA (robotic process automation) multi-instance process where activities 102-114 are automatically performed by one or more RPA robots.

As shown in FIG. 1, multi-instance process 100 is modeled as a directed graph where each activity 102-114 is represented as a node and each transition between activities 102-114 is represented as edges connecting the nodes. The transition between activities represents the execution of multi-instance process 100 from a source activity to a destination activity. Execution of multi-instance process 100 is recorded in the form of an event log.

It should be understood that multi-instance process 100 is not limited to a single multi-instance subprocess 124. Multi-instance process 100 may comprise one or more different multi-instance subprocesses. Furthermore, multi-instance subprocesses may be nested such that one multi-instance subprocess includes another multi-instance subprocess.

Embodiments described herein provide for applying process mining to multi-instance processes, such as, e.g., multi-instance process 100. In one embodiment, an event log of a multi-instance process is divided into a main log and one or more sublogs, a process graph is generated for the main log and for each of the one or more sublogs, and the generated process graphs are combined into a combined process graph. Advantageously, embodiments described herein enable performance of process mining techniques to multi-instance processes.

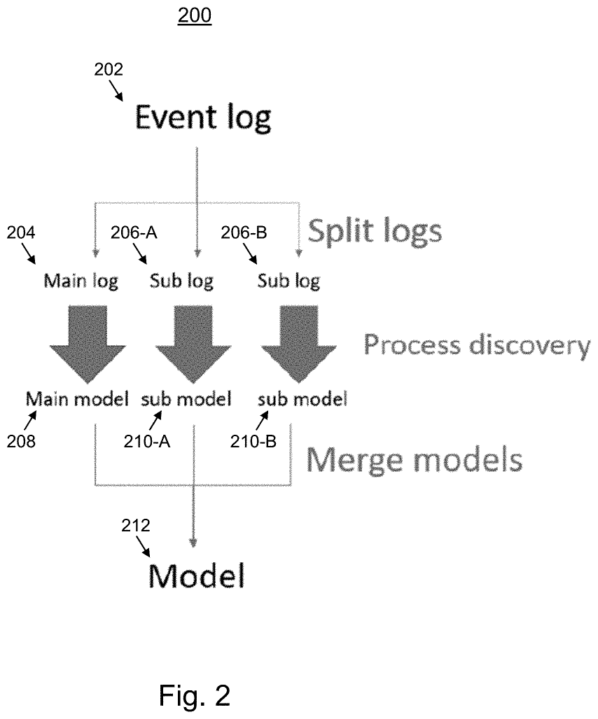

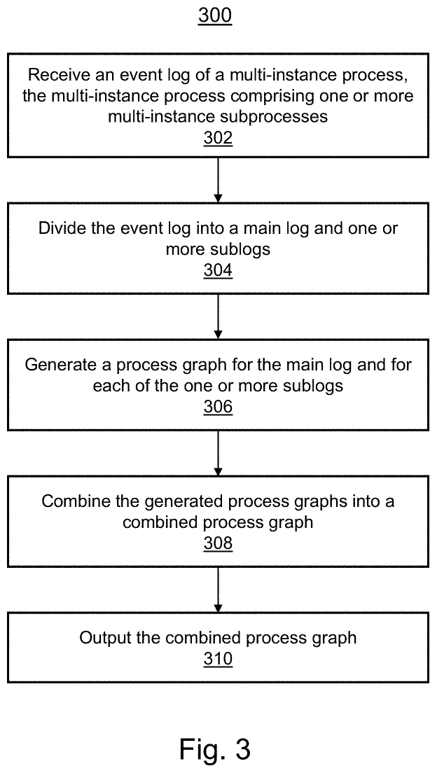

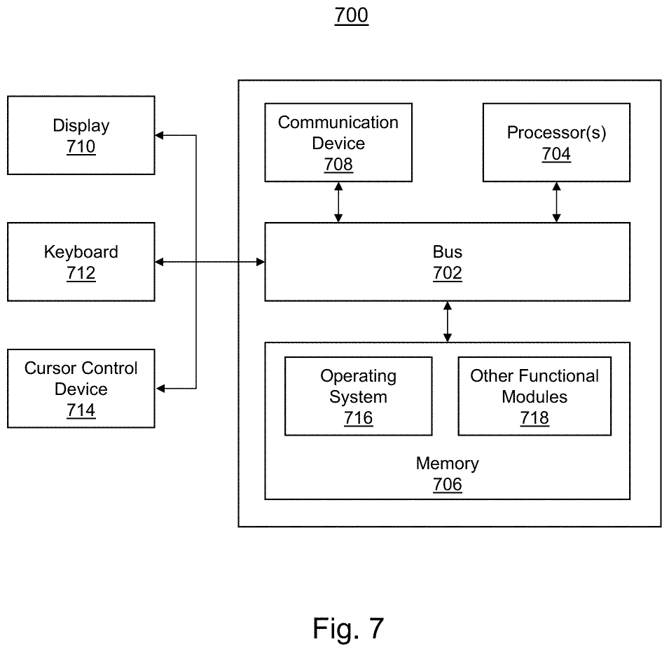

FIG. 2 shows a workflow 200 for performing process mining on a multi-instance process, in accordance with one or more embodiments. FIG. 3 shows a method 300 for performing process mining on a multi-instance process, in accordance with one or more embodiments. FIG. 2 and FIG. 3 will be described together with continued reference to FIG. 1. The steps of method 300 may be performed by one or more suitable computing devices, such as computer 700 of FIG. 7. Method 300 will be described for performing process discovery. However, method 300 may be adapted to perform other process mining tasks, such as, e.g., conformance checking, graph layout and visualization, etc.

At step 302, an event log for a multi-instance process is received. The multi-instance process comprises one or more multi-instance subprocesses. In one example, the multi-instance process is multi-instance process 100 comprising multi-instance subprocess 124 of FIG. 1 and/or the event log is event log 202 of FIG. 2. The multi-instance process may be represented as a hierarchy such that the overall process of the multi-instance process is at a top level of the hierarchy, a first multi-instance subprocess of the multi-instance process is at a next lower level of the hierarchy, a second multi-instance subprocess nested within the first multi-instance subprocess is at a next lower level of the hierarchy, and so on. For example, in FIG. 1, the overall process of multi-instance process 100 is at a top level of the hierarchy and multi-instance subprocess 124 is at a next lower level of the hierarchy.

The event log may be maintained during one or more instances of execution of the multi-instance process by recording events occurring during the one or more instances of execution of the multi-instance process. An event refers to the execution of an activity at a particular time and for a particular case. A process case identifier (ID) identifies a particular instance of execution of the multi-instance process, which corresponds to a case. A subprocess case ID (subID) identifies a particular instance of execution of a multi-instance subprocess.

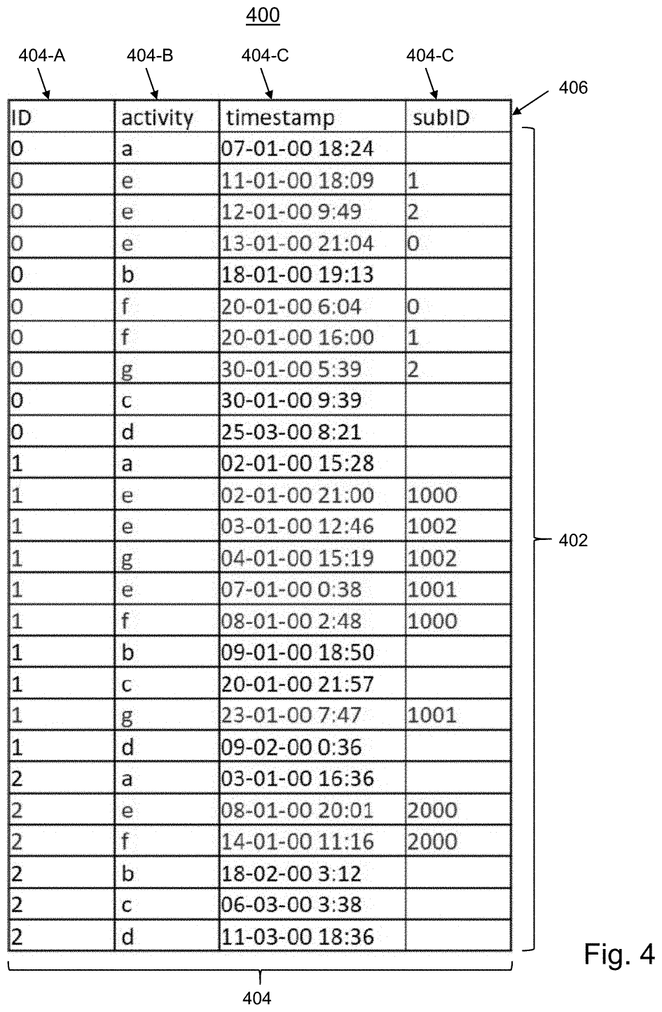

FIG. 4 shows an exemplary event log 400 of multi-instance process 100 of FIG. 1, in accordance with one or more embodiments. Event log 400 records events occurring during three instances of execution of multi-instance process 100, corresponding to case ID 0 through case ID 2 in event log 400. As shown in FIG. 4, event log 400 is formatted as a table having rows 402 each corresponding to an event and columns 404 each identifying an attribute of the event, identified in header row 406, at a cell at which rows 402 and columns 404 intersect. In particular, each row 402 is associated with an event representing the execution of an activity 102-112 (identified in column 404-B), a time stamp associated with the execution of the activity 102-112 (identified in column 404-C), a case ID identifying the instance of execution of the multi-instance process 100 (identified in column 404-A), and a subprocess case ID identifying the instance of execution of multi-instance subprocess 124 (identified in column 404-D). It should be understood that event log 400 may be in any suitable format and may include additional columns 404 identifying other attributes of events.

At step 304 of FIG. 3, the event log is divided into a main log and one or more sublogs. The main log corresponds to the overall process of the multi-instance process and each of the one or more sublogs corresponds to a respective one of the one or more multi-instance subprocesses. For example, FIG. 2 shows event log 202 being divided into main log 204 and sublogs 206-A and 206-B. To divide the event log, for each respective hierarchical level of the multi-instance process, 1) higher level events, which correspond to a hierarchical level higher than the respective hierarchical level, are omitted from the event log and 2) events of each of the multi-instance subprocesses at the respective hierarchical level are collapsed into a single compound event. The main log and the sublogs are mined from the event log using the case ID and subcase ID respectively. Dividing the event log at the top hierarchical level (representing the overall process of the multi-instance process as a whole) results in the main log and dividing the event log for hierarchical levels below the top hierarchical level results in the sublogs.

To omit higher level events, the subprocess case ID is used as the case identifier and the event log is effectively filtered based on the subprocess case ID. For example, the sublog corresponding to multi-instance subprocess 124 may be generated by filtering out events where the subprocess case ID has a null value, as events with no case identifier are ignored. In one example, in event log 400 of FIG. 4, events with a null value in column 404-C are filtered out.

To collapse subprocesses of the multi-instance process, events for each instance of a subprocess are collapsed into a single activity. However, collapsing the events of a subprocess into a single activity can result in some ambiguity as to where the subprocess event needs to be inserted into the main log. For example, in event log 400 of FIG. 4, looking at events subprocess case ID subID=1, it can be seen that one event takes place before the event with activity B and the other event takes place after the event with activity B, resulting in two different ways of inserting the events into the main log. In one embodiment, the events of a subprocess are inserted into the main log by tracking all possible effective insertion positions and randomly inserting it in one of the effective insertion positions. This is done by keeping track of the first and last activity in each subprocess and identifying activities in the main process that take place between the start and end of the subprocess. The effective insertion positions are positions before or after the activities in the main process. Accordingly, subprocess events will be inserted in the effective positions with equal probability.

At step 306 of FIG. 3, a process graph is generated for the main log and for each of the one or more sublogs. For example, in FIG. 2, main model 208 is generated for main log 204, submodel 210-A is generated from sublog 206-A, and submodel 210-B is generated from sublog 206-B. Any suitable process discovery algorithm may be used for generating a process graph based on a main log or a sublog.

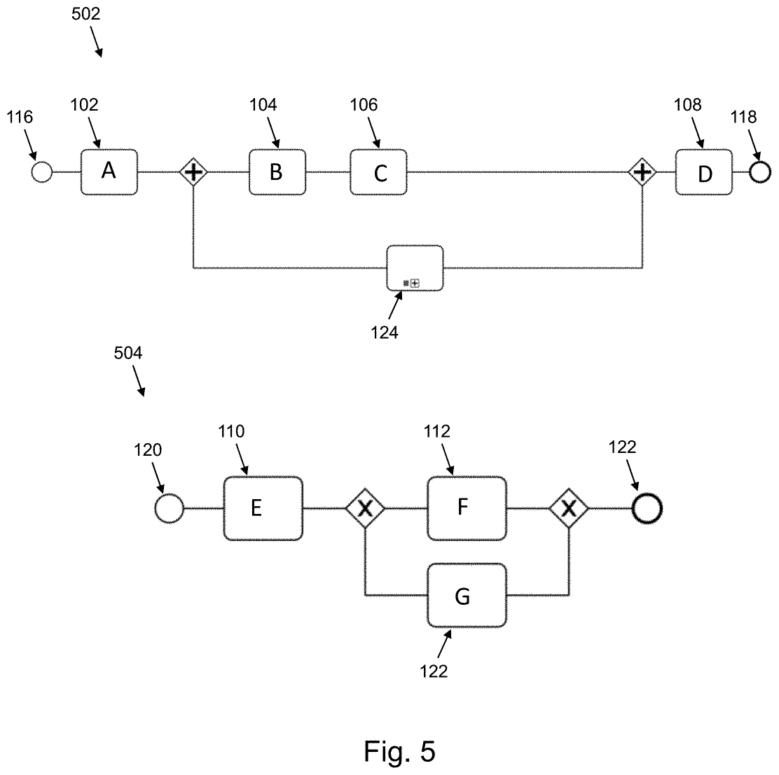

FIG. 5 shows a process graph 502 generated from a main log of multi-instance process 100 of FIG. 1 and a process graph 504 generated from a sublog of multi-instance process 100 of FIG. 1, in accordance with one or more embodiments. Main graph 502 is generated from the main log of multi-instance process 100, which represents the overall process of multi-instance process 100, and subgraph 504 is generated from the sublog of multi-instance process 100, which corresponds to multi-instance subprocess 124. As shown in FIG. 5, main graph 502 is generated by collapsing subprocess 124 (there are no higher level processes) and sub process 504 is generated by removing events associated with activities A 102-D 108 (there are no subprocesses of multi-instance subprocess 124).

At step 308, the generated process graphs are combined into a combined process graph. For example, in FIG. 2, main model 208, submodel 210-A, and submodel 210-B are combined into model 212. The generated process graphs are combined two at a time, where one process graph corresponds to a subgraph and the other process graph corresponds to the main graph (the graph that the subgraph is to be inserted into). In order to identify where a subprocess starts and ends, two new node types are introduced: a startMISP node and an endMISP node, where MISP refers to multi-instance subprocess. The startMISP node and the endMISP node respectively represent the start and end of a multi-instance process.

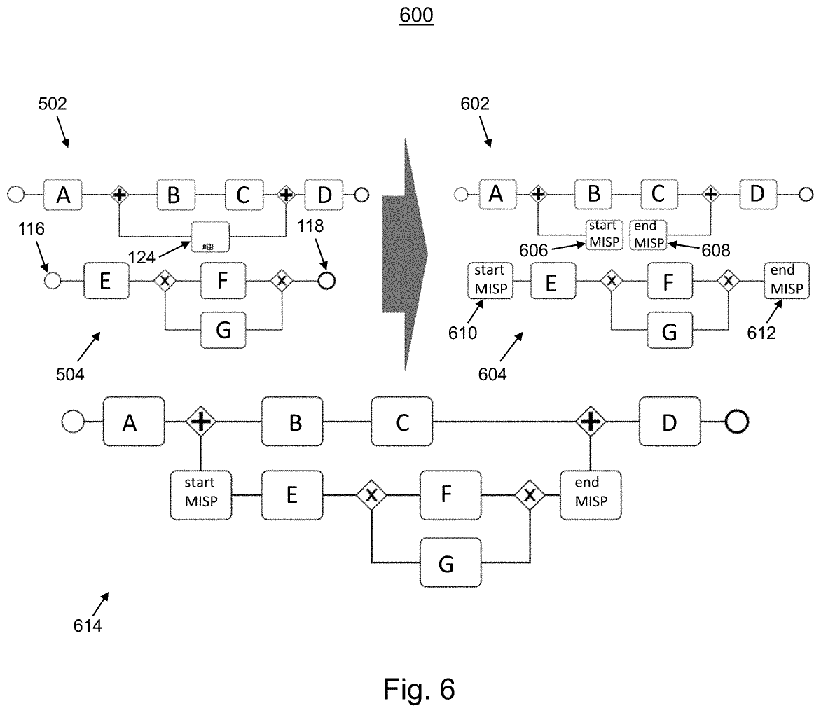

FIG. 6 shows a workflow 600 for combining main graph 502 and subgraph 504 of FIG. 5 into a combined process graph, in accordance with one or more embodiments. In main graph 502, multi-instance subprocess 124 is replaced with startMISP node 606 and endMISP node 608 to generate graph 602. In subgraph 504, start node 116 is replaced with startMISP node 610 and end node 118 is replaced with endMISP node 612 to generate graph 604. Graph 610 is then inserted into graph 602 by inserting startMISP node 610 of subgraph 604 at startMISP node 606 of main graph 602 and inserting endMISP node 612 of subgraph 604 at endMISP node 608 of main graph 602.

At step 310 of FIG. 3, the combined process graph is output. In one embodiment, the process model may be output by, for example, displaying the combined process graph on a display device of a computer system, storing the combined process graph on a memory or storage of a computer system, or by transmitting the combined process graph to a remote computer system.

In one embodiment, other process mining tasks may be performed based on method 300. Such other process mining tasks may include, e.g., conformance checking, graph layout and visualization, etc. Other process mining tasks are also contemplated.

In one embodiment, method 300 may be modified to perform conformance checking of a multi-instance process. Accordingly, an event log for a multi-instance process is received (step 302) and the event log is divided into a main log and one or more sublogs (step 304). However, to avoid losing information due to collapsing events of multi-instance subprocesses into a single subprocess event, each multi-instance subprocess is instead replaced with the same activity. A process graph for the main log and for each of the one or more sublogs are generated (step 306) and the generated process graphs are combined into a combined process graph (step 308). To combine the generated process graphs, the startMISP node of the subgraph is inserted at the startMISP node of the main graph and the endMISP node of the subgraph is inserted at the endMISP node of the main graph. However, in addition, a self loop is added such that the endMISP node loops back to the startMISP node in the combined process graph. Accordingly, the effect of having multiple multi-instance subprocess activities in the log for each instance of a multi-instance subprocess. Known conformance checking techniques may then be applied to the combined process graph to identify conforming behavior and non-conforming behavior. Conforming behavior refers to events that occur in both the log and in the generated graph. Non-conforming behavior refers to events that occur in the log but not in the generated graph (log only behavior) or events that occur in the graph but not in the log (model only behavior).

In one embodiment, method 300 may be modified to perform graph visualization of a multi-instance process. Accordingly, an event log for a multi-instance process is received (step 302), the event log is divided into a main log and one or more sublogs (step 304), and a process graph for the main log and for each of the one or more sublogs are generated (step 306). The graph layout is then computed at each hierarchical level separately. In particular, the process graphs are filtered so that only a current hierarchical level remains. The startMISP and endMISP nodes are retained, and an artificial edge between the startMISP node and the endMISP node is added. The order in which the graph layout at each hierarchical level is computed is based on a post order tree traversal. This ensure that when a subgraph is inserted into a main graph, the graph layout of the subgraph is already computed. The generated process graphs are then combined into a combined process graph (step 308). However, prior to combining the generated process graphs, certain edges and nodes are repositioned to make room for the computed graph layout of the subgraph. If a node is positioned between the startMISP and endMISP nodes vertically, it is moved to the left if the node is left from the startMISP node and to the right if the node is to the right from the startMISP node. All nodes that are positioned below the endMISP node are moved down. Each node is moved from (x₁,y₁) to (x′₁,y′₁) and the edge is moved from (x₂,y₂) to (x′₂,y′₂). The translation of control point (x,y) is computed as follows:

$$Δ x = ( 1 - \frac{i}{n - 1} ) Δ {x}_{1} + ( \frac{i}{n - 1} ) Δ {x}_{2}$$

$$Δ y = ( 1 - \frac{i}{n - 1} ) Δ {y}_{1} + ( \frac{i}{n - 1} ) Δ {y}_{2}$$

where i is the index of the control point, n is the number of control points in the path, Δx=x′−x, Δx₁=x′₁−x₁, Δx₂=x′₂−x₂, Δy=y′−y, Δy₁=y′₁−y₁, Δy₂=y′₂−y₂. The control points are moved based on the translation of the from- and to-node of the corresponding edge with a weight based on the relative distance between the control point and the from- and to-node. The dimensions of the current layout are then determined and stored to be made available when the current layout is inserted as a subprocess. This is done by finding the minimal and maximal values of the x- and y-coordinates of the control points. The difference between the maximal and minimal y-coordinate is the height of the subprocess: height=yₘₐₓ−yₘᵢₙ. The amounts to translate the nodes to the left or right are determined by: translationLeft=x_{startMISP}−xₘᵢₙ and translationRight=xₘₐₓ−x_{startMISP}.

FIG. 7 is a block diagram illustrating a computing system 700 configured to execute the methods, workflows, and processes described herein, including those shown in FIGS. 2 and 3, according to an embodiment of the present invention. In some embodiments, computing system 700 may be one or more of the computing systems depicted and/or described herein. Computing system 700 includes a bus 702 or other communication mechanism for communicating information, and processor(s) 704 coupled to bus 702 for processing information. Processor(s) 704 may be any type of general or specific purpose processor, including a Central Processing Unit (CPU), an Application Specific Integrated Circuit (ASIC), a Field Programmable Gate Array (FPGA), a Graphics Processing Unit (GPU), multiple instances thereof, and/or any combination thereof. Processor(s) 704 may also have multiple processing cores, and at least some of the cores may be configured to perform specific functions. Multi-parallel processing may be used in some embodiments.

Computing system 700 further includes a memory 706 for storing information and instructions to be executed by processor(s) 704. Memory 706 can be comprised of any combination of Random Access Memory (RAM), Read Only Memory (ROM), flash memory, cache, static storage such as a magnetic or optical disk, or any other types of non-transitory computer-readable media or combinations thereof. Non-transitory computer-readable media may be any available media that can be accessed by processor(s) 704 and may include volatile media, non-volatile media, or both. The media may also be removable, non-removable, or both.

Additionally, computing system 700 includes a communication device 708, such as a transceiver, to provide access to a communications network via a wireless and/or wired connection according to any currently existing or future-implemented communications standard and/or protocol.

Processor(s) 704 are further coupled via bus 702 to a display 710 that is suitable for displaying information to a user. Display 710 may also be configured as a touch display and/or any suitable haptic I/O device.

A keyboard 712 and a cursor control device 714, such as a computer mouse, a touchpad, etc., are further coupled to bus 702 to enable a user to interface with computing system. However, in certain embodiments, a physical keyboard and mouse may not be present, and the user may interact with the device solely through display 710 and/or a touchpad (not shown). Any type and combination of input devices may be used as a matter of design choice. In certain embodiments, no physical input device and/or display is present. For instance, the user may interact with computing system 700 remotely via another computing system in communication therewith, or computing system 700 may operate autonomously.

Memory 706 stores software modules that provide functionality when executed by processor(s) 704. The modules include an operating system 716 for computing system 700 and one or more additional functional modules 718 configured to perform all or part of the processes described herein or derivatives thereof.

One skilled in the art will appreciate that a “system” could be embodied as a server, an embedded computing system, a personal computer, a console, a personal digital assistant (PDA), a cell phone, a tablet computing device, a quantum computing system, or any other suitable computing device, or combination of devices without deviating from the scope of the invention. Presenting the above-described functions as being performed by a “system” is not intended to limit the scope of the present invention in any way, but is intended to provide one example of the many embodiments of the present invention. Indeed, methods, systems, and apparatuses disclosed herein may be implemented in localized and distributed forms consistent with computing technology, including cloud computing systems.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like. A module may also be at least partially implemented in software for execution by various types of processors. An identified unit of executable code may, for instance, include one or more physical or logical blocks of computer instructions that may, for instance, be organized as an object, procedure, or function. Nevertheless, the executables of an identified module need not be physically located together, but may include disparate instructions stored in different locations that, when joined logically together, comprise the module and achieve the stated purpose for the module. Further, modules may be stored on a computer-readable medium, which may be, for instance, a hard disk drive, flash device, RAM, tape, and/or any other such non-transitory computer-readable medium used to store data without deviating from the scope of the invention. Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The foregoing merely illustrates the principles of the disclosure. It will thus be appreciated that those skilled in the art will be able to devise various arrangements that, although not explicitly described or shown herein, embody the principles of the disclosure and are included within its spirit and scope. Furthermore, all examples and conditional language recited herein are principally intended to be only for pedagogical purposes to aid the reader in understanding the principles of the disclosure and the concepts contributed by the inventor to furthering the art, and are to be construed as being without limitation to such specifically recited examples and conditions. Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future.

What is claimed is:

1. A computer implemented method for performing process mining on a multi-instance process comprising one or more multi-instance subprocesses, the method comprising:
dividing an event log for the multi-instance process into a main log and one or more sublogs by collapsing events of each of the one or more multi-instance subprocesses into a single activity;
generating a process graph for the main log and for each of the one or more sublogs;
combining the generated process graphs into a combined process graph; and
outputting the combined process graph.

2. The computer implemented method of claim 1, wherein each of the one or more sublogs corresponds to a respective one of the one or more multi-instance subprocesses.

3. The computer implemented method of claim 1, wherein dividing the event log into a main log and one or more sublogs comprises for each respective hierarchical level of the multi-instance process, omitting events corresponding to a hierarchical level higher than the respective hierarchical level of the multi-instance process from the event log.

4. The computer implemented method of claim 3, wherein omitting events corresponding to a hierarchical level higher than the respective hierarchical level of the multi-instance process from the event log comprises:
filtering the event log based on a subprocess identifier.

5. The computer implemented method of claim 1, wherein combining the generated process graphs into a combined process graph comprises:
inserting the process graph generated for a sublog corresponding to a particular one of the one or more multi-instance subprocesses into the process graph generated for the main log by:
replacing the particular multi-instance subprocess in the process graph generated for the main log with a start multi-instance subprocess node and an end multi-instance subprocess node;
replacing a start node and an end node in the process graph generated for the sublog corresponding to the particular multi-instance subprocess with a start multi-instance subprocess node and an end multi-instance subprocess node respectively; and
inserting the start multi-instance subprocess node and the end multi-instance subprocess node of the process graph generated for the sublog corresponding to the particular multi-instance subprocess at the start multi-instance subprocess node and the end multi-instance subprocess node of the process graph generated for the main log respectively.

6. The computer implemented method of claim 1, wherein combining the generated process graphs into a combined process graph comprises inserting a loop from an end node of each respective one of the one or more multi-instance subprocesses to a start node of the respective one of the one or more multi-instance subprocesses, the method further comprising:
performing conformance checking based on the combined process graph.

7. The computer implemented method of claim 1, further comprising:
separately computing a graph layout for the process graphs generated for the main log and for each of the one or more sublogs.

8. The computer implemented method of claim 1, wherein outputting the combined process graph comprises:
displaying the combined process graph.

9. The computer implemented method of claim 1, wherein the multi-instance process is a robotic process automation multi-instance process.

10. An apparatus comprising:
a memory storing computer instructions for performing process mining on a multi-instance process comprising one or more multi-instance subprocesses; and
at least one processor configured to execute the computer instructions, the computer instructions configured to cause the at least one processor to perform operations of:
dividing an event log for the multi-instance process into a main log and one or more sublogs by collapsing events of each of the one or more multi-instance subprocesses into a single activity;
generating a process graph for the main log and for each of the one or more sublogs;
combining the generated process graphs into a combined process graph; and
outputting the combined process graph.

11. The apparatus of claim 10, wherein each of the one or more sublogs corresponds to a respective one of the one or more multi-instance subprocesses.

12. The apparatus of claim 10, wherein dividing the event log into a main log and one or more sublogs comprises for each respective hierarchical level of the multi-instance process, omitting events corresponding to a hierarchical level higher than the respective hierarchical level of the multi-instance process from the event log.

13. The apparatus of claim 12, wherein omitting events corresponding to a hierarchical level higher than the respective hierarchical level of the multi-instance process from the event log comprises:
filtering the event log based on a subprocess identifier.

14. The apparatus of claim 10, wherein combining the generated process graphs into a combined process graph comprises:
inserting the process graph generated for a sublog corresponding to a particular one of the one or more multi-instance subprocesses into the process graph generated for the main log by:
replacing the particular multi-instance subprocess in the process graph generated for the main log with a start multi-instance subprocess node and an end multi-instance subprocess node;
replacing a start node and an end node in the process graph generated for the sublog corresponding to the particular multi-instance subprocess with a start multi-instance subprocess node and an end multi-instance subprocess node respectively; and
inserting the start multi-instance subprocess node and the end multi-instance subprocess node of the process graph generated for the sublog corresponding to the particular multi-instance subprocess at the start multi-instance subprocess node and the end multi-instance subprocess node of the process graph generated for the main log respectively.

15. A computer program embodied on a non-transitory computer-readable medium for performing process mining on a multi-instance process comprising one or more multi-instance subprocesses, the computer program configured to cause at least one processor to perform operations comprising:
dividing an event log for the multi-instance process into a main log and one or more sublogs by collapsing events of each of the one or more multi-instance subprocesses into a single activity;
generating a process graph for the main log and for each of the one or more sublogs;
combining the generated process graphs into a combined process graph; and
outputting the combined process graph.

16. The computer program of claim 15, wherein each of the one or more sublogs corresponds to a respective one of the one or more multi-instance subprocesses.

17. The computer program of claim 15, wherein combining the generated process graphs into a combined process graph comprises inserting a loop from an end node of each respective one of the one or more multi-instance subprocesses to a start node of the respective one of the one or more multi-instance subprocesses, the operations further comprising:
performing conformance checking based on the combined process graph.

18. The computer program of claim 15, the operations further comprising:
separately computing a graph layout for the process graphs generated for the main log and for each of the one or more sublogs.

19. The computer program of claim 15, wherein outputting the combined process graph comprises:
displaying the combined process graph.

20. The computer program of claim 15, wherein the multi-instance process is a robotic process automation multi-instance process.
